(19) United States
(12) Patent Application Publication
(10) Pub. No.: US 2026/0059177 A1
(43) Pub. Date: Feb. 26, 2026

(54) METHOD AND ELECTRONIC DEVICE FOR PROVIDING CONTENT

(71) Applicant: SAMSUNG ELECTRONICS CO., LTD., Suwon-si (KR)

(72) Inventors: Sanghyun JANG, Suwon-si (KR); Daehyun KIM, Suwon-si (KR); Jinsun KIM, Suwon-si (KR); Sanghee LEE, Suwon-si (KR)

(73) Assignee: SAMSUNG ELECTRONICS CO., LTD., Suwon-si (KR)

(21) Appl. No.: 19/377,306

(22) Filed: Nov. 3, 2025

Related U.S. Application Data
(63) Continuation of application No. PCT/KR2024/003773, filed on Mar. 26, 2024.

(30) Foreign Application Priority Data
May 8, 2023 (KR) 10-2023-0059325

(51) Int. Cl. H04N 21/81; H04N 21/431

(52) U.S. Cl. CPC H04N 21/816; H04N 21/4318

(57) ABSTRACT

A method and electronic device for providing content. The electronic device includes obtaining information related to first content being reproduced, generate, based on the information related to the first content, a user interface including at least one of an editable content element in relation to the first content and a generatable content element in relation to the first content, receive a user input selecting a content element through the user interface, generate, based on the content element being selected according to the user input, second content corresponding to the first content, and display personalized content including the first content and the second content.

### CROSS-REFERENCE TO RELATED APPLICATION

This application is a continuation application, under 35 U.S.C. § 111(a), of international application No. PCT/KR2024/003773, filed on Mar. 26, 2024, which claims priority under 35 U. S. C. § 119 to Korean Patent Application No. 10-2023-0059325, filed on May 8, 2023, in the Korean Intellectual Property Office, the disclosures of which are incorporated by reference herein in their entireties.

### TECHNICAL FIELD

The present disclosure relates to an electronic device for generating personalized content, and an operating method thereof.

### BACKGROUND ART

Recently, generative artificial intelligence that generates new data based on input data has emerged as technology using artificial intelligence, and content generated by using such generative artificial intelligence is increasing. Editing content by using generative artificial intelligence technology is somewhat difficult for general users, and thus, an intuitive and efficient user interface is required.

It is required to provide a new content experience to users by realizing, through an optimized user interface, an environment for using generative artificial intelligence, so that various customization options for appearance, speech, text, or the like of an object in content may be provided.

### DISCLOSURE OF INVENTION

### Solution to Problem

According to an aspect of the present disclosure, a method, performed by an electronic device, of providing content may be provided. The method may include obtaining information in relation to first content being reproduced. The method may include generating, based on the information about the first content, a user interface including at least one of an editable content element in relation to the first content and a generatable content element in relation to the first content. The method may include receiving a user input selecting a content element through the user interface. The method may include generating, based on the content element being selected according to the user input, second content corresponding to the first content. The method may include generating personalized content including the first content and the second content.

According to an aspect of the present disclosure, an electronic device for providing content may be provided. The electronic device may include a communication interface, a display, a memory to store one or more instructions, and at least one processor configured to execute the one or more instructions which are stored in the memory. The at least one processor may be configured to execute the one or more instructions to obtain information in relation to first content being reproduced. The at least one processor may be configured to execute the one or more instructions to generate, based on the information in relation to the first content, a user interface including at least one of an editable content element in relation to the first content and a generatable content element in relation to the first content. The at least one processor may be configured to execute the one or more instructions to receive a user input selecting a content element through the user interface. The at least one processor may be configured to execute the one or more instructions to generate, based on the content element being selected according to the user input, second content corresponding to the first content. The at least one processor may be configured to execute the one or more instructions to display, on a screen of the display, personalized content including the first content and the second content.

According to an aspect of the present disclosure, there may be provided a computer-readable recording medium having recorded thereon a program for executing any one of methods by which an electronic device provides content, described above and below.

### BRIEF DESCRIPTION OF DRAWINGS

FIG. 1 is a diagram schematically showing an electronic device providing a content service, according to an embodiment of the present disclosure.

FIG. 2 is a flowchart of operations in which an electronic device generates content, according to an embodiment of the present disclosure.

FIG. 3 is a diagram illustrating general operations of an electronic device, according to an embodiment of the present disclosure.

FIG. 4A is a diagram for describing an operation in which an electronic device executes a second content generation mode, according to an embodiment of the present disclosure.

FIG. 4B is a diagram for describing an operation in which an electronic device executes a second content generation mode, according to an embodiment of the present disclosure.

FIG. 5 is a diagram for describing pre-defined settings used by an electronic device to generate a user interface, according to an embodiment of the present disclosure.

FIG. 6 is a diagram for describing an example in which an electronic device generates second content, according to an embodiment of the present disclosure.

FIG. 7A is a diagram for describing a user interface for generating second content, the user interface being generated by an electronic device, according to an embodiment of the present disclosure.

FIG. 7B is a diagram for describing an operation in which an electronic device generates second content in a background process, according to an embodiment of the present disclosure.

FIG. 8A is a diagram showing an example in which an electronic device provides personalized content, according to an embodiment of the present disclosure.

FIG. 8B is a diagram showing an example in which an electronic device provides personalized content, according to an embodiment of the present disclosure.

FIG. 9 is a diagram showing an example in which an electronic device provides personalized content, according to an embodiment of the present disclosure.

FIG. 10A is a diagram for describing an operation in which a user of an electronic device generates second content through a user input, according to an embodiment of the present disclosure.

FIG. 10B is a diagram showing a result obtained when an electronic device generates second content according to a user input, according to an embodiment of the present disclosure.

FIG. 10C is a diagram for describing an operation in which a user of an electronic device edits second content by using another electronic device, according to an embodiment of the present disclosure.

FIG. 11A is a diagram for describing an operation in which an electronic device stores second content information in association with user information, according to an embodiment of the present disclosure.

FIG. 11B is a diagram for describing an operation in which an electronic device stores second content information in association with user information, according to an embodiment of the present disclosure.

FIG. 12 is a block diagram showing a configuration of an electronic device, according to an embodiment of the present disclosure.

### MODE FOR THE INVENTION

The terms used in the specification will be briefly defined, and the present disclosure will be described in detail. Throughout the present disclosure, the expression “at least one of a, b, or c” indicates only a, only b, only c, both a and b, both a and c, both b and c, all of a, b, and c, or variations thereof.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

An expression used in the singular may encompass the expression in the plural, unless it has a clearly different meaning in the context. Terms used herein, including technical or scientific terms, may have the same meaning as commonly understood by one of ordinary skill in the art described in the present specification. Further, the terms including ordinal numbers such as “first”, “second”, and the like used in the present specification may be used to describe various components, but the components should not be limited by the terms. The above terms are used only to distinguish one component from another.

In addition, unless explicitly described to the contrary, the word “comprise” and variations such as “comprises” or “comprising” will be understood to imply the inclusion of stated elements but not the exclusion of any other elements. In addition, terms such as “unit” and “module” described in the specification denote a unit that processes at least one function or operation, which may be implemented in hardware or software, or implemented in a combination of hardware and software.

Hereinafter, embodiments of the present disclosure will be described in detail with reference to the accompanying drawings such that one of ordinary skill in the art may easily implement the embodiments of the present disclosure. However, the present disclosure may be implemented in various different forms and is not limited to the embodiment described herein. Also, in the drawings, parts irrelevant to the description are omitted in order to clearly describe the present disclosure, and like reference numerals designate like elements throughout the specification.

Hereinafter, the present disclosure will be described in detail with reference to accompanying drawings.

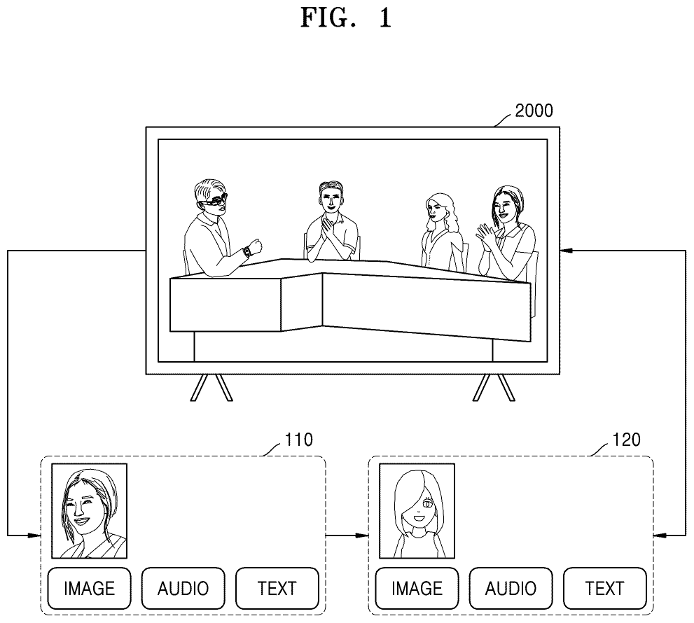

FIG. 1 is a diagram schematically showing an electronic device providing a content service, according to an embodiment of the present disclosure.

An electronic device 2000 according to an embodiment may be a device that includes a display and outputs an image and/or a moving image. For example, the electronic device 2000 may include a smart television (TV), a smartphone, a tablet personal computer (PC), a laptop PC, or a frame type display, but is not limited thereto, and the electronic device 2000 may be implemented in various types and forms including a display. The electronic device 2000 may include a speaker and output audio.

In the present disclosure, original content reproduced in the electronic device 2000 may be referred to as first content. The electronic device 2000 according to an embodiment may customize the first content reproduced in the electronic device 2000. For example, the electronic device 2000 may generate second content 120 that is new content, based on content elements 110 included in the first content. The second content 120 may include at least one of an image, audio, and text.

The electronic device 2000 may generate personalized content by combining the generated second content 120 with the first content. For example, the electronic device 2000 may replace at least one of an image, audio, and text, which are the content elements 110 included in the first content, with the second content 120.

In an embodiment, a generative artificial intelligence model may be used when the electronic device 2000 generates the second content 120. The generative artificial intelligence model may refer to an artificial intelligence model configured to generate content having new characteristics or similar characteristics as the content elements 110 included in the first content. The electronic device 2000 may generate the second content 120 by using the generative artificial intelligence model, and provide, to a user, the personalized content including the first content and the second content 120.

Detailed operations in which the electronic device 2000 generates the personalized content by generating the second content and applying the second content 120 to the original content will be described below in further detail with reference to diagrams described below and descriptions thereof.

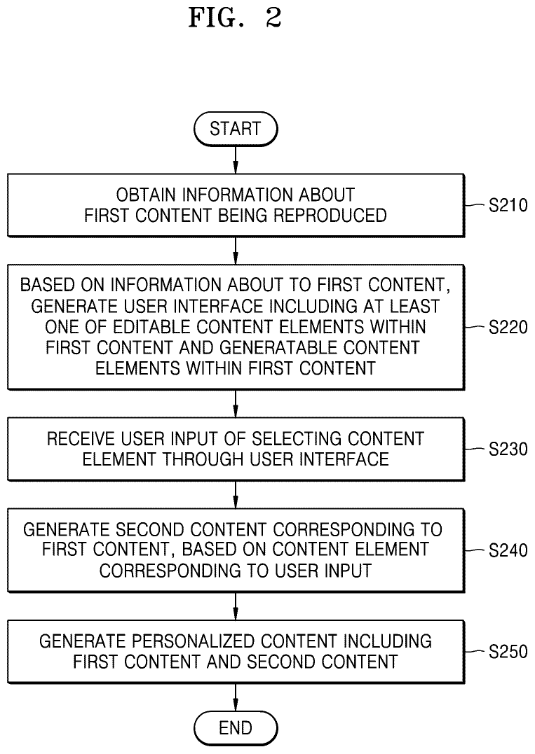

FIG. 2 is a flowchart of operations in which an electronic device generates content, according to an embodiment of the present disclosure.

In operation S210, the electronic device 2000 obtains information about first content being reproduced.

In the present disclosure, the first content may indicate various types of media content, such as a movie, a drama series, a documentary, an entertainment, a TV program, and other video content, and may also be referred to as multimedia content.

In an embodiment, the first content may be in a digital file format manufactured in a standardized method of packaging multimedia data. For example, a media container format, such as MP4, AVI, MKV, MOV, or WMV, may be used, but is not limited thereto.

The first content may include various types of media data. For example, the first content may include a video, audio, and text. The electronic device 2000 may identify the first content being reproduced in the electronic device 2000 and obtain the information about the first content.

The first content may include various types of information about content. For example, the first content may include, as metadata, a title, a producer, a reproduction time, a genre, cast information, platform information, and channel information. However, the information about the first content is not limited to above examples.

In operation S220, the electronic device 2000 generates a user interface including at least one of editable content elements within the first content and generatable content elements within the first content, based on the information about the first content. The user interface indicates an intuitive interface allowing the user of the electronic device 2000 to customize the first content.

In an embodiment, the electronic device 2000 may generate the user interface including the editable content elements within the first content. The editable content elements may include at least one of an image, audio, and text included in the first content. For example, the electronic device 2000 may generate the user interface enabling the user to edit the appearance of a character in the first content.

In an embodiment, the electronic device 2000 may generate the user interface including the generatable content elements within the first content. The generatable content elements may include at least one of an image, audio, and text, which may be added to the first content. For example, the electronic device 2000 may generate the user interface enabling the user to add a new virtual object in the first content.

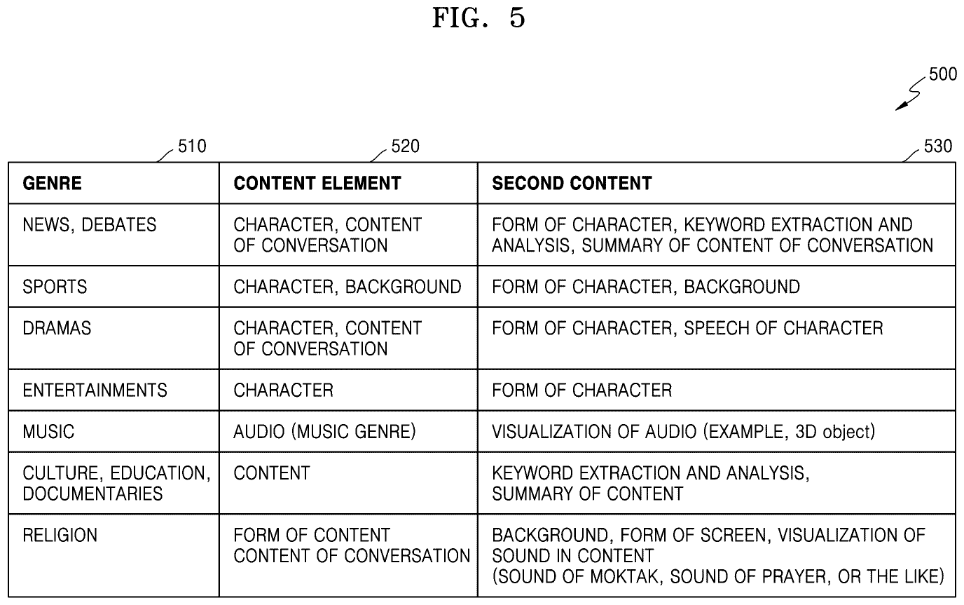

In an embodiment, the user interface may be generated based on the information about the first content. For example, the electronic device 2000 may generate the user interface such that the user interface includes a pre-defined content element for each genre, based on a genre of the first content. An operation in which the electronic device 2000 generates the user interface based on pre-defined settings will be further described with reference to FIG. 5.

In operation S230, the electronic device 2000 may receive a user input of selecting a content element through the user interface.

In an embodiment, the user of the electronic device 2000 may change a content element within the first content or generate a new content element to be added to the first content, through the user interface.

In an embodiment, the user of the electronic device 2000 may select, through the user interface, at least one of an image, audio, and text included in the first content. For example, the user of the electronic device 2000 may select the character in the first content through the user interface, so as to edit the appearance of the character in the first content.

In an embodiment, the user of the electronic device 2000 may select, through the user interface, at least one of an image, audio, and text to be added to the first content. For example, the user of the electronic device 2000 may select a virtual object through the user interface so as to add the virtual object to the first content.

In an embodiment, the electronic device 2000 may change the content element within the first content or generate the new content element, based on the user input. In the present disclosure, a content element changed and/or generated by the electronic device 2000 will be referred to as “second content”.

In operation S240, the electronic device 2000 according to an embodiment generates second content corresponding to the first content, based on the content element corresponding to the user input.

In an embodiment, the electronic device 2000 may generate the second content by changing the content element corresponding to the user input, from among the content elements within the first content. For example, the second content may be an image of a new character obtained by changing the appearance of the character within the first content.

In an embodiment, the electronic device 2000 may generate the second content by generating the content element corresponding to the user input. For example, the second content may be an image of the virtual object that may be added to the first content.

In an embodiment, the electronic device 2000 may generate the second content by using the generative artificial intelligence model. The electronic device 2000 may generate the second content including at least one of an image, audio, and text.

In operation S250, the electronic device 2000 according to an embodiment generates personalized content including the first content and the second content.

In an embodiment, the first content is original content and the second content is content generated in the electronic device 2000 by the user. Accordingly, when the second content is combined with the first content, the personalized content of the user, which is not provided to other users, may be generated.

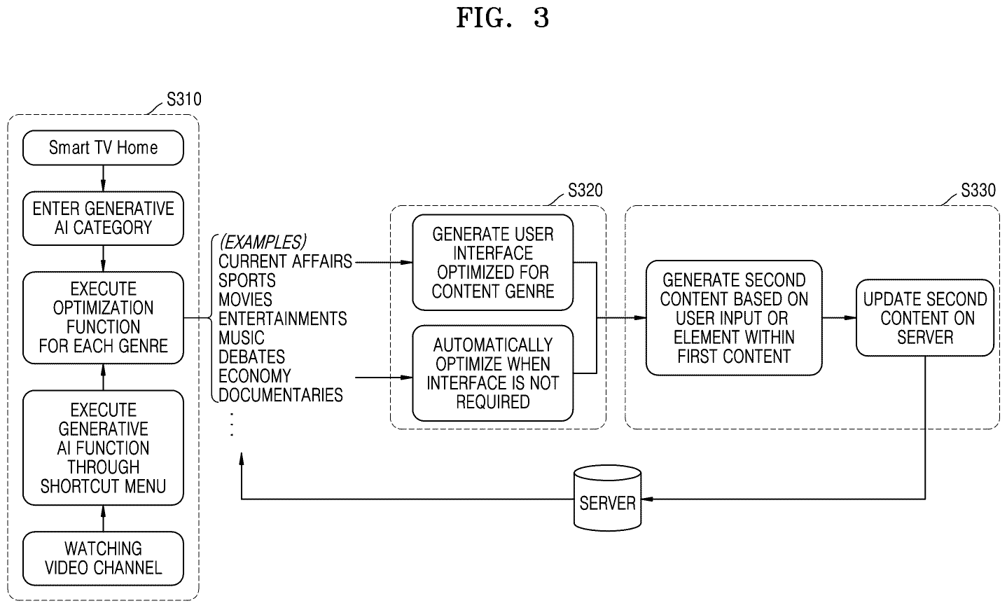

FIG. 3 is a diagram illustrating general operations of an electronic device, according to an embodiment of the present disclosure.

In operation S310, the electronic device 2000 executes a second content generation mode. Second content indicates content corresponding to first content that is original content being reproduced or capable of being reproduced by the electronic device 2000. For example, the second content includes a content element, such as an image, audio, or text, may be additionally combined with the first content. Operations in which the electronic device 2000 generates second content and generates personalized content, described above with reference to FIG. 2, may be performed by executing the second content generation mode.

In an embodiment, a home menu of the electronic device 2000 may include the second content generation mode (e.g., a generative artificial intelligence mode). The electronic device 2000 may identify that the user has executed the second content generation mode from the home menu.

In an embodiment, while the electronic device 2000 is operating, the user of the electronic device 2000 may execute the second content generation mode (e.g., the generative artificial intelligence mode) through a shortcut menu. In this case, while the first content is being reproduced, the electronic device 2000 may identify execution of the second content generation mode and directly execute the second content generation mode.

The electronic device 2000 may obtain information about the first content so as to generate the second content. In detail, the electronic device 2000 may identify a genre of the first content and execute an optimization function corresponding to the identified genre. The genre of the first content may be classified as, for example, current affairs, sports, movies, entertainments, music, debates, economy, or documentaries, but is not limited thereto.

In operation S320, the electronic device 2000 may determine whether to generate a user interface for generating the second content, based on the information about the first content. For example, the electronic device 2000 may determine whether to generate the user interface, based on the genre of the first content.

The electronic device 2000 may generate the user interface for generating the second content that is additional content corresponding to the first content, according to the genre of the first content. The user interface may include at least one of editable content elements within the first content and generatable content elements within the first content.

The user of the electronic device 2000 may generate the second content through a user input through the user interface. In this case, the user interface provided to the user may have different formats depending on the genre of the first content, and may be optimized according to genres, for each genre of content. When the genre of the first content is set to not require generation of a user interface, the electronic device 2000 may automatically perform optimization to generate the second content related to the first content.

In operation S330, the electronic device 2000 may generate the second content. For example, the electronic device 2000 may generate the second content based on a user input through the user interface. Alternatively, the electronic device 2000 may generate the second content based on an element within the first content. The generated second content may be updated on a server in association with user information. For example, when account information is present as the user logs in to the electronic device 2000, the electronic device 2000 may accumulate and store the second content generated for the user, and manage the second content while updating the second content. A history of the second content stored for the user may be used by the user later to generate another second content for another first content.

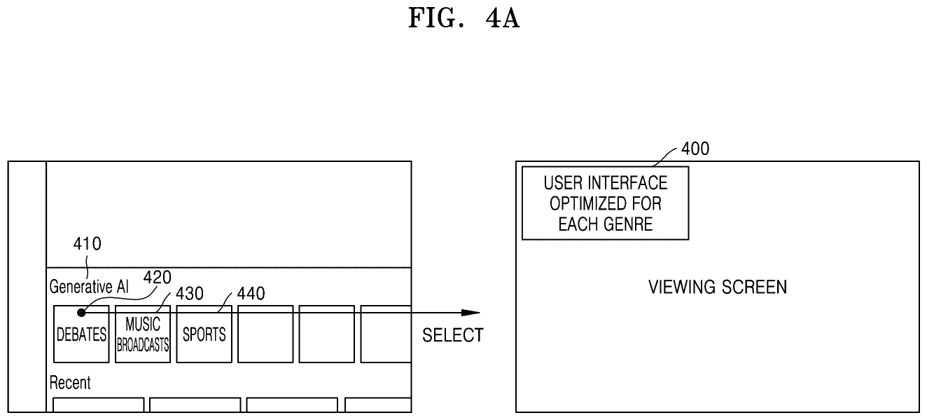

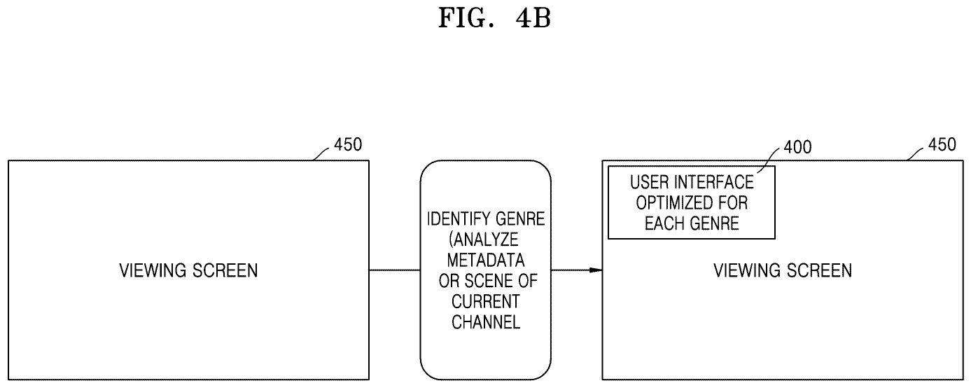

FIG. 4A is a diagram for describing an operation in which an electronic device executes a second content generation mode, according to an embodiment of the present disclosure.

In an embodiment, the electronic device 2000 may display, on the home menu, a menu 410 of the second content generation mode (e.g., the generative artificial intelligence mode). Also, a genre of content may be displayed on the menu 410 of the second content generation mode. For example, content genres, such as debates 420, music broadcasts 430, and sports 440, may be displayed.

When a content genre is selected by the user, the electronic device 2000 may generate a user interface 400 optimized for each genre corresponding to the content genre, and display the same on a screen of the electronic device 2000. For example, when a genre of the debates 420 is selected from the electronic device 2000, a plurality of pieces of content included in the genre of the debates 420 are displayed. When the user selects one piece of content (first content) from the plurality of pieces of content, the first content may be reproduced. In this case, a viewing screen of the first content is displayed and the user interface 400 for generating second content corresponding to the first content may be displayed. In the example of FIG. 4A, because the content genre selected by the user is the debates 420, the user interface 400 optimized for the genre of the debates 420 may be displayed. However, this is only an example, and a user interface optimized for each genre may be differently displayed depending on a genre of the first content. This will be further described with reference to FIG. 5.

FIG. 4B is a diagram for describing an operation in which an electronic device executes a second content generation mode, according to an embodiment of the present disclosure.

In an embodiment, while the electronic device 2000 is operating, the user of the electronic device 2000 may execute the second content generation mode (e.g., the generative artificial intelligence mode) through the shortcut menu. In this case, while a viewing screen 450 of the first content is being displayed, the electronic device 2000 may execute the second content generation mode and display the user interface 400 optimized for each genre together with the viewing screen 450 of the first content.

In FIG. 4A, the user selects the genre of the first content whereas in FIG. 4B, the second content generation mode is executed by the user while the first content is being reproduced without selecting a genre. In this case, the electronic device 2000 may perform a series of operations to identify a genre of the first content.

In an embodiment, the electronic device 2000 may use metadata of the first content, which is the information about the first content. The metadata may include a title, a producer, a reproduction time, a genre, cast information, platform information, and channel information of the first content, but is not limited thereto. When the metadata does not include genre information of the first content, the electronic device 2000 may infer the genre of the first content by using other pieces of information (e.g., the title or the like) included in the metadata. When the metadata includes the genre information of the first content, the electronic device 2000 may identify the genre of the first content.

In an embodiment, when the genre of the first content is not inferred from the metadata or the metadata is not obtained, the electronic device 2000 may analyze the first content to identify the genre of the first content. For example, the electronic device 2000 may obtain scene context data by performing scene analysis. The electronic device 2000 may use one or more artificial intelligence models for the scene analysis.

The electronic device 2000 may select one or more video frames in video data included in the first content, and detect at least one object in the video frame. The electronic device 2000 may use an object detection model that is an artificial intelligence model for object detection. The object detection model may be a deep neural network model configured to output information representing objects detected by receiving an image. For example, the object detection model may output a bounding box representing the objects detected by receiving the image. The object detection model may be implemented by using well-known various deep neural network architectures and algorithms or through modifications of the well-known various deep neural network architectures and algorithms.

The electronic device 2000 may recognize a category of the at least one object detected in the video frame. The electronic device 2000 may use an object recognition model that is an artificial intelligence model for object recognition. The object recognition model may be a deep neural network model configured to output information representing object class label(s) by receiving an image. For example, the object recognition model may receive an image obtained by cropping an object, and output one or more object class labels (e.g., “vehicle”, “person”, and the like) and a confidence score. The object recognition model may be implemented by using well-known various deep neural network architectures and algorithms or through modifications of the well-known various deep neural network architectures and algorithms.

The electronic device 2000 may detect a relationship between the recognized objects. The electronic device 2000 may use an object relationship detection model that is an artificial intelligence model for object relationship detection. The object relationship detection model may be a deep neural network model configured to receive information about detected objects and output information representing a relationship between the objects. For example, the object relationship detection model may be a model that receives information about detected objects “person a” and “person “b”, and outputs a relationship “next to” between the two objects, the relationship representing that people are on a roof. The object relationship detection model may be implemented by using well-known various deep neural network architectures and algorithms or through modifications of the well-known various deep neural network architectures and algorithms.

The electronic device 2000 may generate a scene graph based on result data of the object detection, the object recognition, and the object relationship detection. One or more nodes of the scene graph indicate one or more objects, and one or more edges of the scene graph indicate relationships between the one or more objects. Also, the electronic device 2000 may generate scene context based on the scene graph. The electronic device 2000 may generate the scene context for each of the one or more video frames and identify the genre of the first content based on the scene context.

In the example of FIG. 4B, when the first content of the viewing screen 450 is “TV debates”, the genre of the first content is identified as debates through the scene analysis, and the user interface 400 optimized for the genre of debates may be displayed. However, this is only an example, and a user interface optimized for each genre may be differently displayed depending on a genre of the first content. This will be further described with reference to FIG. 5.

FIG. 5 is a diagram for describing pre-defined settings used by an electronic device to generate a user interface, according to an embodiment of the present disclosure.

In an embodiment, the electronic device 2000 may use pre-defined settings 500 when generating a user interface for generating second content corresponding to first content.

The pre-defined settings 500 may define a content element 520 to be included in the user interface, according to a genre 510 of the first content, and define second content 530 to be generated through the user interface.

For example, when the genre 510 of the first content is “news, debates”, pre-defined content elements corresponding to “news, debates” may be “character, content of conversation”. In this case, the user interface for generating the second content 530 may include “character, content of conversation” that are the content elements.

The user of the electronic device 2000 may generate the second content 530 through the user interface. For example, the user may edit “character” that is the content element for the first content of the genre 510 of “news, debates”. In detail, the user may generate a 3-dimensional (3D) character as the second content 530. The user may change the appearance of a character appearing in news or debates into a 3D character by using the second content 530. For example, the user may generate “content of conversation” that is the content element. In detail, the user may generate, as the second content 530, keyword extraction and analysis results, a summary of the content of conversation, or the like. The user may use the second content 530 to superimpose the keyword analysis results, the summary of the content of conversation, or the like on a screen on which news or debates are in progress. The second content 530, such as the keyword analysis results, the summary of the content of conversation, or the like, may be provided to the user after the reproducing of the first content in the electronic device 2000 has been ended, or may be provided to the user through an electronic device other than the electronic device 2000.

The electronic device 2000 according to an embodiment may generate the user interface optimized for each genre of the first content, based on the pre-defined settings 500. In another example, when the genre 510 of the first content is “sports”, the content elements 520 included in the user interface for generating the second content 530 may be “character, background”, and the user may generate the second content 530 by editing or generating “character, background” through the user interface.

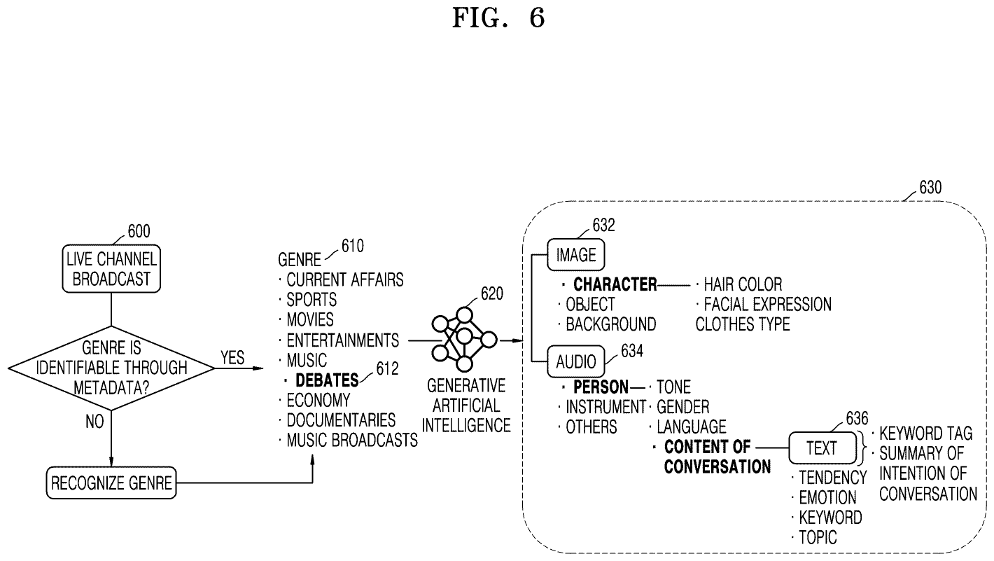

FIG. 6 is a diagram for describing an example in which an electronic device generates second content, according to an embodiment of the present disclosure.

Referring to FIG. 6, the electronic device 2000 according to an embodiment may identify first content being reproduced (e.g., a live channel broadcast 600).

The electronic device 2000 may obtain information about the first content being reproduced. For example, the electronic device 2000 may identify a genre 610 of the first content, based on metadata including a title, a producer, a reproduction time, a genre, cast information, platform information, and channel information of the first content. Alternatively, the electronic device 2000 may obtain scene context data through scene analysis performed on the first content, and recognize a genre of the first content. An operation in which the electronic device 2000 recognizes a genre of the first content has been described above with reference to FIG. 4B, and thus, redundant descriptions are omitted.

In an embodiment, the electronic device 2000 may generate a user interface for generating second content 630, based on the genre 610 of the first content. The user interface may include at least one of editable content elements within the first content and generatable content elements within the first content, and may include pre-defined content elements optimized for each genre.

For example, when the genre 610 of the first content is “debates 612”, the user interface may include “character, content of conversation” that are pre-defined content elements corresponding to the “debates 612”. The user of the electronic device 2000 may generate the second content 630 according to the user's preference, for example, by editing a character appearing in a debate or by generating a keyword or a summary related to content of conversation, through the user interface.

In an embodiment, the electronic device 2000 may generate the second content 630 by using a generative artificial intelligence model 620. The generative artificial intelligence model 620 may be a deep neural network model configured to perform at least one task from among image generation (or video generation or 3D object generation), audio generation (or speech generation), and text generation. The generative artificial intelligence model 620 may be implemented by using well-known various deep neural network architectures and algorithms or through modifications of the well-known various deep neural network architectures and algorithms.

In an embodiment, there may be a plurality of generative artificial intelligence models 620 used by the electronic device 2000. For example, a generative artificial intelligence model may include a first generative artificial intelligence model generating an image, a second generative artificial intelligence model generating audio, and a third generative artificial intelligence model generating text.

The first generative artificial intelligence model may be an artificial intelligence model configured to perform an image generation task. The first generative artificial intelligence model may be implemented by using well-known various deep neural network architectures and algorithms for generating an image, video, or 3D object, or through modifications of the well-known various deep neural network architectures and algorithms. The first generative artificial intelligence model may be implemented by using, for example, a generative adversarial network (GAN) or a variational autoencoder (VAE), but is not limited thereto.

In an embodiment, the second content 630 may be an image 632. The electronic device 2000 may generate the image 632 by using the first generative artificial intelligence model. For example, the electronic device 2000 may generate an image having new characteristics or an image having similar characteristics as a character, an object, and a background of the first content, by using the first generative artificial intelligence model. In detail, a new image may be generated by changing a hair color, a facial expression, a clothes type, or the like of the character.

The second generative artificial intelligence model may be an artificial intelligence model configured to perform an audio generation task. The second generative artificial intelligence model may be implemented by using well-known various deep neural network architectures and algorithms for generating audio, such as speech, music, and other sound, or through modifications of the well-known various deep neural network architectures and algorithms. The second generative artificial intelligence model may be implemented by using, for example, a recurrent neural network (RNN), VAE, WaveNet, Tacotron, or the like, but is not limited thereto.

In an embodiment, the second content 630 may be audio 634. The electronic device 2000 may generate the audio 634 by using the second generative artificial intelligence model. For example, the electronic device 2000 may generate audio having new characteristics or audio having similar characteristics as audio related to a person, an instrument, or the like of the first content, by using the second generative artificial intelligence model. In detail, new speech may be generated by changing a tone, voice, a gender, a language, content of conversation, or the like, with respect to speech of the person.

The third generative artificial intelligence model may be an artificial intelligence model configured to perform a text generation task. The third generative artificial intelligence model may be implemented by using well-known various deep neural network architectures and algorithms for generating text, or through modifications of the well-known various deep neural network architectures and algorithms. The third generative artificial intelligence model may be implemented by using, for example, RNN or a transformer, but is not limited thereto.

In an embodiment, the second content 630 may be text 636. The electronic device 2000 may generate the text 636 by using the third generative artificial intelligence model. For example, the electronic device 2000 may generate text having new characteristics or text having similar characteristics as text related to content of conversation of a person of the first content, by using the third generative artificial intelligence model. In detail, text representing a tendency, emotion, keyword, topic, or the like of the content of conversation may be generated for the content of conversation of the person.

The first generative artificial intelligence model, the second generative artificial intelligence model, and the third generative artificial intelligence model described above may be implemented as one integrated generative artificial intelligence model.

The electronic device 2000 may generate the second content 630 including at least one of the image 632, the audio 634, and the text 636, and generate personalized content by combining the generated second content 630 to the first content (e.g., the live channel broadcast 600). Then, the electronic device 2000 may provide the personalized content to the user.

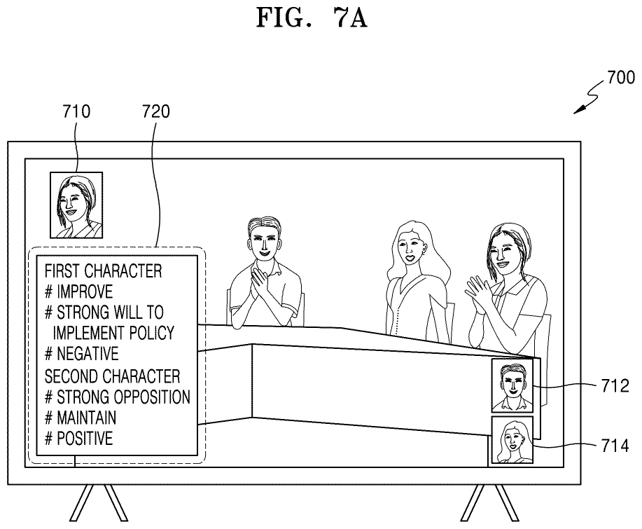

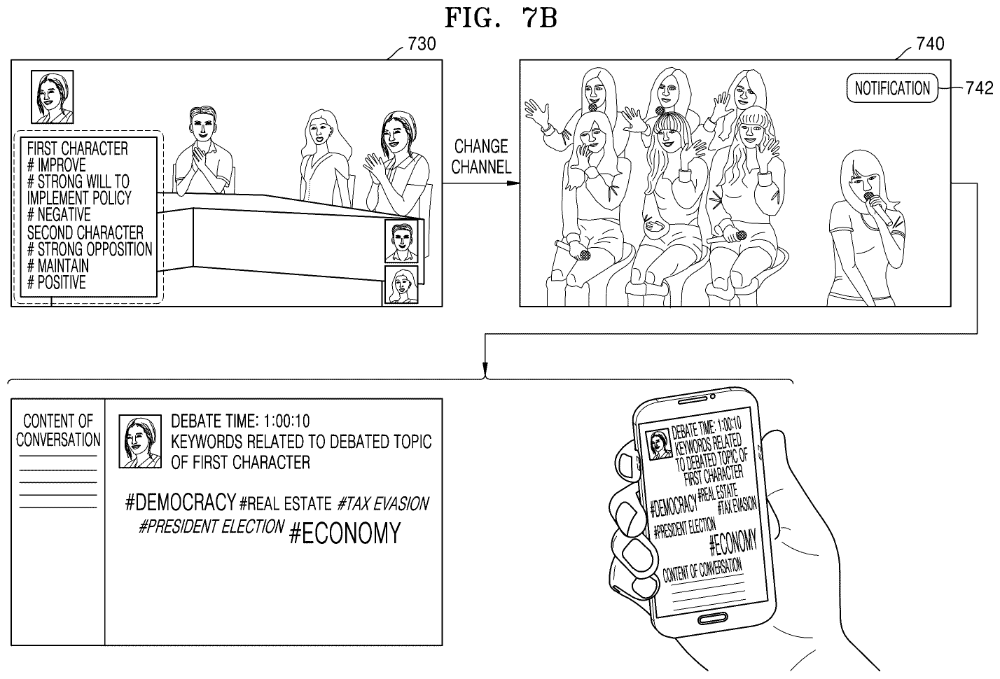

FIG. 7A is a diagram for describing a user interface for generating second content, the user interface being generated by an electronic device, according to an embodiment of the present disclosure.

In an embodiment, the electronic device 2000 generates a user interface 700 including at least one of editable content elements within first content and generatable content elements within first content, based on information about the first content.

In an embodiment, the user interface 700 may have been optimized according to a genre of the first content. For example, when the genre of the first content is “debates”, the user interface 700 for using second content may include content elements optimized for the genre of “debates”. In detail, the user interface 700 may include characters and content of conversation, which correspond to main content elements in the genre of “debates”.

The user of the electronic device 2000 may generate the second content by generating a content element or by selecting a content element displayed on the user interface 700 and editing the content element.

For example, the user may select a first character 710 that is a content element displayed on the user interface 700. The user may generate a new image (second content) by changing a hair color, a facial expression, a clothes type, or the like of the first character 710. Alternatively, the user may generate new speech (second content) by changing a tone, voice, a gender, a language, content of conversation, or the like with respect to speech of the first character 710. In this case, when a debate program between characters, which is the first content, is reproduced in the electronic device 2000, the appearance, the speech, or the like of the first character 710 may be replaced by the second content generated by the user. In a same manner, the user of the electronic device 2000 may change appearances, speech, or the like of characters by applying the second content generated by the user to appearances, speech, or the like of a second character 712 and a third character 714 through the user interface 700.

For example, the user may select content of conversation 720 that is a content element displayed on the user interface 700. The user may generate text representing tendencies, emotions, keywords, or topics of content of conversation with respect to content of conversation of the first character 710 and content of conversation of the second character 712. In this case, when the debate program between the characters, which is the first content, is reproduced, a summary of the content of conversation of the first character 710 and a summary of the content of conversation of the second character 712, which are the second content, may be displayed together.

FIG. 7B is a diagram for describing an operation in which an electronic device generates second content in a background process, according to an embodiment of the present disclosure.

Referring to a first screen 730 illustrated in FIG. 7B, the electronic device 2000 according to an embodiment may display personalized content including first content and second content. At this time, the second content may be automatically generated or may be generated according to the user's request.

In an embodiment, the first content being reproduced in the electronic device 2000 may be changed to another content. For example, the user may operate the electronic device 2000 to change a channel of the electronic device 2000, and the other content may be displayed as in a second screen 740.

When it is identified that the first content being reproduced in the electronic device 2000 is changed to the other content, the electronic device 2000 may not end generation of the second content but may continue to generate the second content in a background process. For example, the second content generated by the electronic device 2000 may be a summary of the first content. The electronic device 2000 may summarize content of conversation of debate participants until a debate program ends, and provide, to the user, a second content generation notification 742 when the first content being broadcasted on another channel ends.

The user of the electronic device 2000 may check the second content through a screen of the electronic device 2000 or check the second content by using an electronic device other than the electronic device 2000.

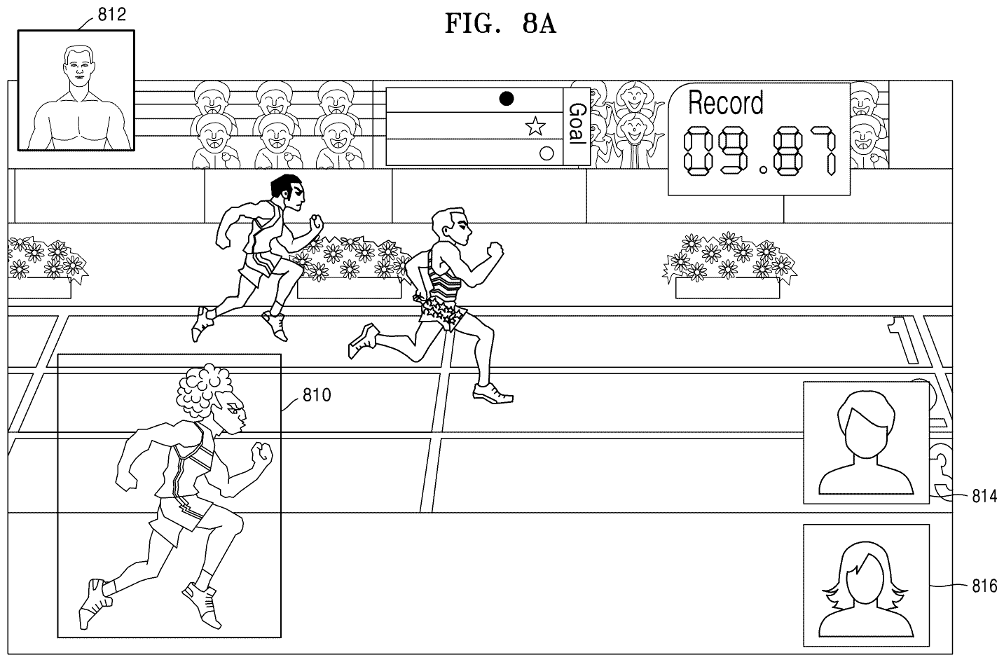

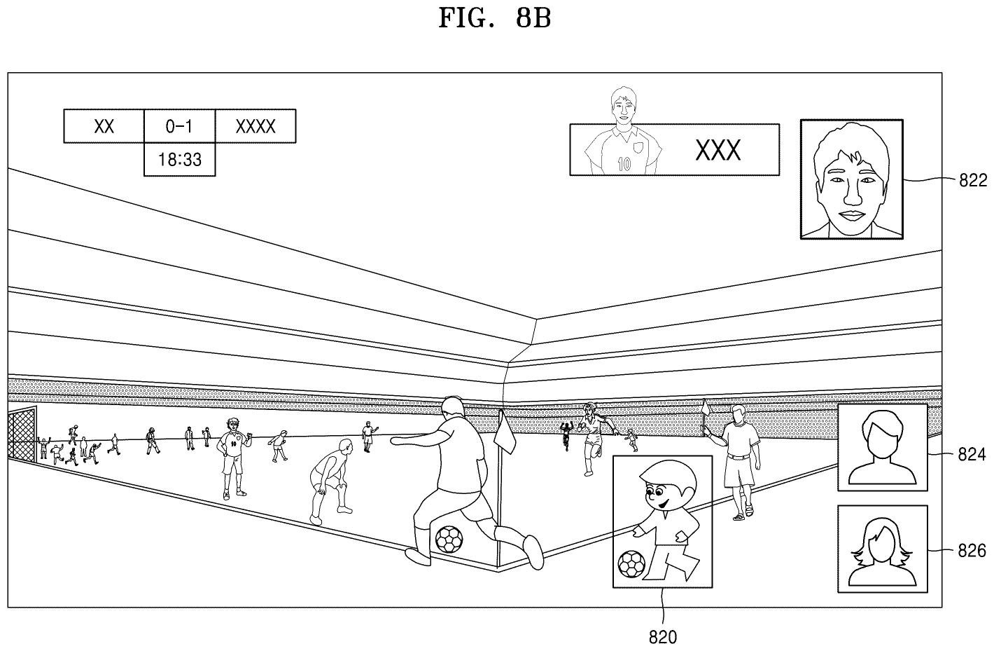

FIG. 8A is a diagram showing an example in which an electronic device provides personalized content, according to an embodiment of the present disclosure.

In an embodiment, the electronic device 2000 may generate personalized content including first content and second content.

The electronic device 2000 may generate a user interface including at least one of editable content elements within the first content and generatable content elements within first content, based on information about the first content. For example, when a genre of the first content is sports (sprint), the electronic device 2000 may display editable pre-defined content elements for a sports genre. The content elements pre-defined for the sports genre may include, for example, characters, a background, and the like, but are not limited thereto.

The electronic device 2000 may receive a user input of selecting a content element through the user interface, and generate the second content based on the content element corresponding to the user input.

For example, when the electronic device 2000 has selected a first athlete 812 participating in the sprint, the electronic device 2000 may generate second content by changing an appearance of the first athlete 812 (e.g., a hair color, a facial expression, a clothes type, or the like) through a generative artificial intelligence model. Accordingly, when content of the sprint is reproduced, the second content that is the changed appearance may be applied to the first athlete 812 and displayed instead of the actual appearance of the first athlete 812. The electronic device 2000 may change appearances of a second athlete 814 and a third athlete 816, based on the user input. At this time, the generative artificial intelligence model may be used.

Alternatively, the electronic device 2000 may generate new content as the second content, in addition to changing a content element in the first content. For example, the electronic device 2000 may generate, as the second content, a virtual character 810 by using the generative artificial intelligence model. The electronic device 2000 may generate graphics as if the virtual character 810 is racing together when the first athlete 812, the second athlete 814, and the third athlete 816 are racing.

FIG. 8B is a diagram showing an example in which an electronic device provides personalized content, according to an embodiment of the present disclosure.

In an embodiment, when a genre of first content is sports (soccer), the electronic device 2000 may display editable pre-defined content elements for a sports genre as described above with reference to FIG. 8A. The content elements pre-defined for the sports genre may include, for example, characters, a background, and the like, but are not limited thereto.

In an embodiment, the electronic device 2000 may generate second content based on information about content and/or a user input. For example, when the first content is a soccer game, information about the first content may include player information. In this case, the electronic device 2000 may identify, within the first content, a first player 822 who is a soccer player preferred by the user or identify, within the first content, the first player 822 based on a user input. Then, the electronic device 2000 may generate second content 820 by adding a graphic effect to the first player 822. For example, the electronic device 2000 may generate, by using a generative artificial intelligence model, the second content 820 by enlarging the first athlete 812, highlighting the first athlete 812, or changing a uniform of the first athlete 812. Accordingly, when content of the soccer game is reproduced, the first player 822 preferred by the user may be displayed with the second content 820 that is a changed appearance applied thereto, instead of an actual appearance. In a same manner, the electronic device 2000 may generate pieces of second content respectively corresponding to a second player 824 and a third player 826, which are content elements present in the first content.

While describing FIGS. 8A and 8B, a sports player is described as an example of an editable and/or generatable content element in case of a sports genre, but an embodiment is not limited thereto. For example, the electronic device 2000 may generate the second content based on other content elements, such as a background, a stadium, audience, and weather, and generate personalized content by combining the generated second content with the first content.

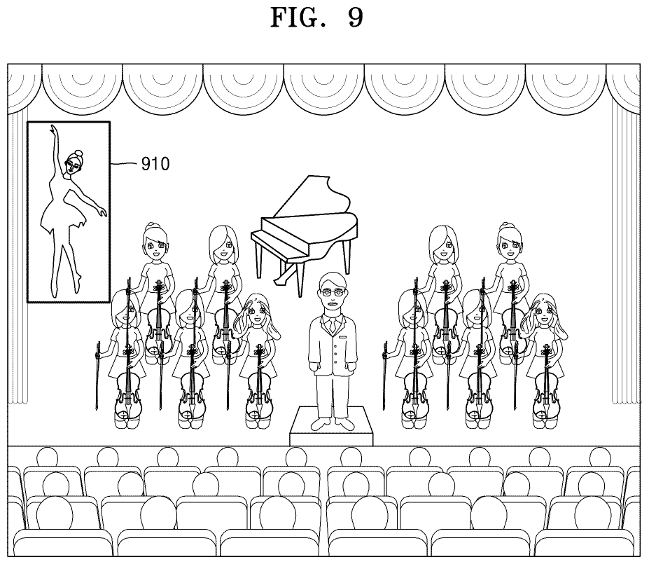

FIG. 9 is a diagram showing an example in which an electronic device provides personalized content, according to an embodiment of the present disclosure.

In an embodiment, the electronic device 2000 may determine whether to generate a user interface for generating second content, based on information about first content. For example, the electronic device 2000 may determine whether to generate the user interface, based on a genre of the first content.

In an embodiment, the user interface for generating the second content may have been pre-defined. For example, when the genre of the first content is “music broadcast”, it may be set that generation of a user interface is not required. In this case, the electronic device 2000 may automatically generate the second content. In detail, when the first content is a broadcast of an orchestra performance, the electronic device 2000 may generate, as the second content, a 3D object 910 obtained by visualizing the orchestra performance by using a generative artificial intelligence model.

The generation of the second content is subject to the second content generation mode being executed in the manner described above with reference to FIGS. 4A and 4B. In other words, the electronic device 2000 may reproduce only the first content when the second content generation mode is not executed, and may generate personalized content including the first content and the second content when the second content generation mode is executed.

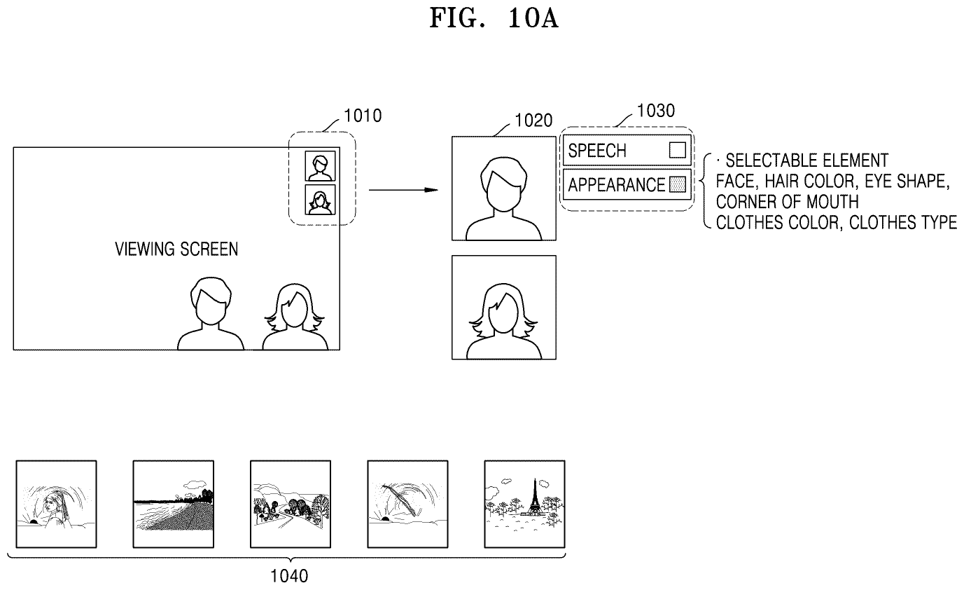

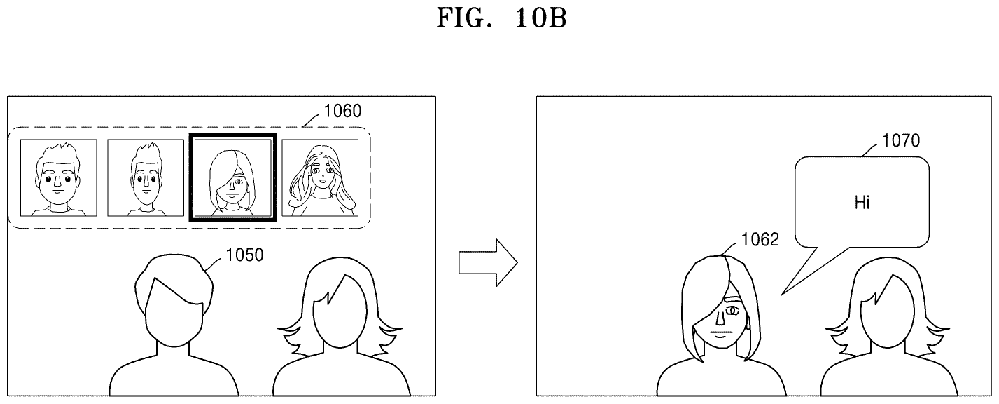

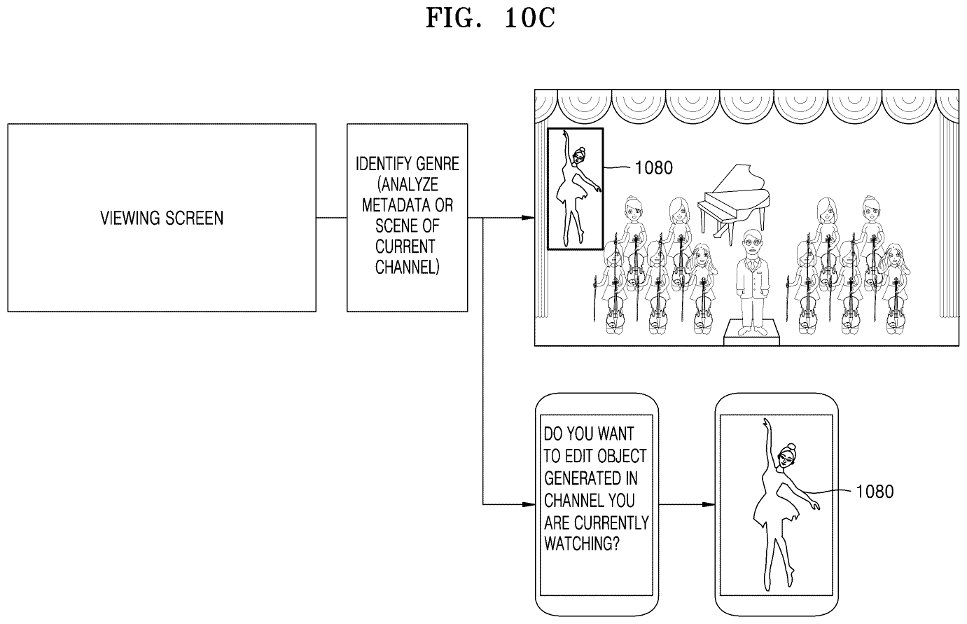

FIG. 10A is a diagram for describing an operation in which a user of an electronic device generates second content through a user input, according to an embodiment of the present disclosure.

In an embodiment, the electronic device 2000 may analyze a genre of first content, based on information about the first content, and provide an intuitive user interface 1010 enabling the first content to be personalized according to the genre of the first content. In this case, the user of the electronic device 2000 may select, from the user interface 1010, a content element to be personalized, and generate second content by editing and/or changing the selected element.

In an embodiment, the electronic device 2000 may generate the second content by using a generative artificial intelligence model. For example, when the user selects an A character 1020 that is a content element, the electronic device 2000 may provide, to the user, options 1030 for changing an appearance, speech, and the like of the A character 1020. For example, when the user selects the appearance from the options 1030, the second content obtained by changing a face, a hair color, an eye shape, a corner of the mouth, a clothes color, a clothes type, or the like may be generated. Alternatively, when the user selects the speech from the options 1030, the second content obtained by changing voice, a tone, a gender, a language, or the like may be generated.

In an embodiment, the electronic device 2000 may provide, to the generative artificial intelligence model, at least one of the appearance and the speech of the A character 1020, and the genre of the first content, as input data. The generative artificial intelligence model may generate and output data having new characteristics or similar characteristics as the input data, based on the input data.

In an embodiment, the electronic device 2000 may display a plurality of style images 1040 applicable to the first content. The electronic device 2000 may receive a user input of selecting one of the plurality of style images 1040. In this case, the second content may be generated by applying the selected style image to the first content. To apply a style selected by the user to the first content, the electronic device 2000 may transfer the style by using the generative artificial intelligence model.

FIG. 10B is a diagram showing a result obtained when an electronic device generates second content according to a user input, according to an embodiment of the present disclosure.

In an embodiment, the electronic device 2000 may display a plurality of results of second content generated by using a generative artificial intelligence model. For example, the electronic device 2000 may display pieces of second content 1060 generated by changing an appearance of a first user 1050 within first content. When the user of the electronic device 2000 selects one of the pieces of second content 1060, personalized content may be generated as a face image 1062 of the selected second content is applied to the first content.

The electronic device 2000 according to an embodiment may generate a plurality of types of second content. For example, the personalized content may include the face image 1062 that is second content of an image type, and a speech balloon 1070 that is second content of a text type, obtained by converting speech of the first user 1050 into text, may be displayed.

In an embodiment, the electronic device 2000 may provide various options for the user to generate the second content. For example, the electronic device 2000 may change a face of a character in the first content, change a hair color, clothes, or the like of the character in the first content, change voice of the character in the first content to specific voice (e.g., excited voice, calm voice, or the like), visualize the voice and display the same as subtitles, or mute the voice.

FIG. 10C is a diagram for describing an operation in which a user of an electronic device edits second content by using another electronic device, according to an embodiment of the present disclosure.

In an embodiment, the electronic device 2000 may allow the user of the electronic device 2000 to use another electronic device (e.g., a smartphone) when executing a second content generation function.

As described above with reference to FIG. 4B, when first content is reproduced, the electronic device 2000 according to an embodiment may perform metadata or scene analysis and display the first content by adding second content 1080 to the first content. In this case, to perform detailed tasks for changing second content, the electronic device 2000 may identify another electronic device of the user. For example, the electronic device 2000 may identify another electronic device connected to a same network (e.g., Wi-Fi) as the electronic device 2000. Alternatively, the electronic device 2000 may identify another electronic device using a user account logged in to the electronic device 2000 through a server.

The user of the electronic device 2000 may edit the second content 1080 by using the other electronic device (e.g., the smartphone). For example, the user may use the other electronic device to change clothes or a gender of a virtual object of the second content 1080. Alternatively, the user may use the other electronic device to change the second content 1080 to another virtual object or to add a new virtual object.

In an embodiment, the electronic device 2000 may provide an interface for identifying the other electronic device of the user and enabling the user to edit and/or generate second content in the other electronic device. In detail, the electronic device 2000 may be a TV and the other electronic device of the user may be a smartphone. Because an interaction through the smartphone is more convenient, the user may perform more detailed and easier tasks of editing and/or generating the second content by using the smartphone.

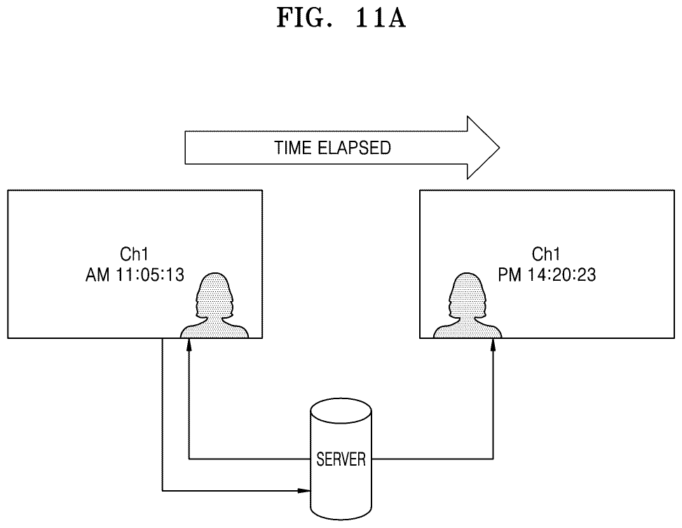

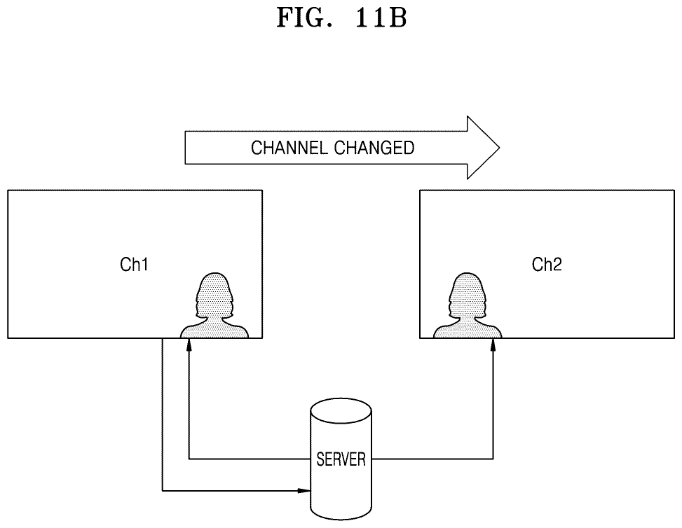

FIG. 11A is a diagram for describing an operation in which an electronic device stores second content information in association with user information, according to an embodiment of the present disclosure.

In an embodiment, the electronic device 2000 may store, in a server, information about second content generated by the user, in association with user information. The information about the second content, stored in association with the user information, may be used at another time in future when the user of the electronic device 2000 is to generate the second content. For example, when first content has been reproduced on channel 1 and the user has generated the second content for the first content, the information about the second content may be stored in the server. When the first content is reproduced again (rebroadcasted) on channel 1 after an elapse of time and the same user is identified, the electronic device 2000 may receive, from the server, the information about the second content in real time and generate personalized content by applying the second content. Also, the electronic device 2000 may additionally provide, to the user, a second content generation function for generating and editing the second content, while providing the second content based on the information about the second content, received from the server.

FIG. 11B is a diagram for describing an operation in which an electronic device stores second content information in association with user information, according to an embodiment of the present disclosure.

In an embodiment, the electronic device 2000 may store, in a server, information about second content generated by the user, in association with user information. The information about the second content, stored in association with the user information, may be used when the user of the electronic device 2000 is to generate the second content on another channel. For example, when first content has been reproduced on channel 1 and the user has generated the second content for the first content, the information about the second content may be stored in the server.

In an embodiment, a broadcast channel of the electronic device 2000 may be changed from channel 1 to channel 2, and a same character as the first content reproduced on channel 1 may appear in content displayed on channel 2. In this case, the electronic device 2000 may receive, from the server, the information about the second content in real time, and generate personalized content by applying the second content. Also, the electronic device 2000 may additionally provide, to the user, a second content generation function for generating and editing the second content, while providing the second content based on the information about the second content, received from the server.

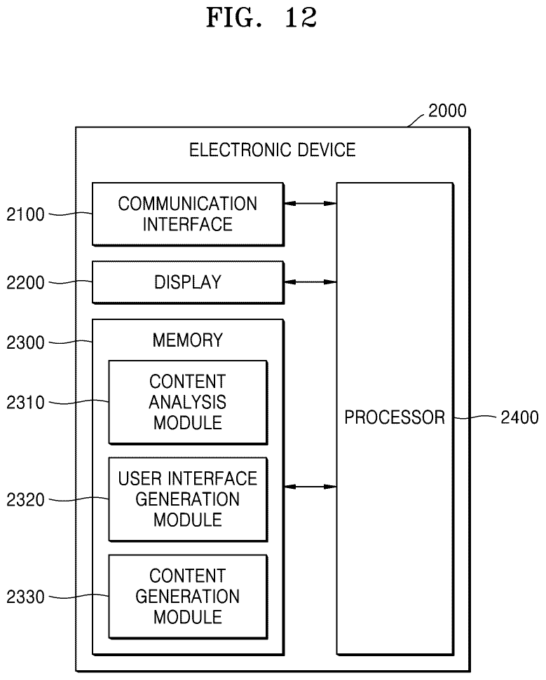

FIG. 12 is a block diagram showing a configuration of an electronic device, according to an embodiment of the present disclosure.

In an embodiment, the electronic device 2000 may include a communication interface 2100, a display 2200, memory 2300, and a processor 2400.

The communication interface 2100 may perform data communication with other electronic devices according to control by the processor 2400.

The communication interface 2100 may include a communication circuit capable of performing data communication between the electronic device 2000 and other devices by using at least one of data communication methods including, for example, wired local area network (LAN), wireless LAN, Wi-Fi, Bluetooth, ZigBee, Wi-Fi direct (WFD), Infrared Data Association (IrDA), Bluetooth low energy (BLE), near field communication (NFC), wireless broadband Internet (Wibro), world interoperability for microwave access (WiMAX), shared wireless access protocol (SWAP), Wireless Gigabit Alliances (WiGig), and radio frequency (RF) communication.

The communication interface 2100 according to an embodiment may transmit, to an external device, data for generating second content. For example, the communication interface 2100 may receive first content, a plurality of artificial intelligence models including a generative artificial intelligence model, and training data for training an artificial intelligence model.

The display 2200 may output an image signal on a screen of the electronic device 2000, according to control by the processor 2400. The display 2200 may display the first content, the second content, and personalized content, according to control by the processor 2400.

The memory 2300 may store instructions, data structures, and program codes, which may be read by the processor 2400. According to embodiments, operations performed by the processor 2400 may be implemented by executing program instructions or codes stored in the memory 2300.

The memory 2300 may include flash memory type memory, hard disk type memory, multimedia card micro type memory, or card type memory (for example, secure digital (SD) or extreme digital (XD) memory), and may include non-volatile memory including at least one of read-only memory (ROM), electrically erasable programmable read-only memory (EEPROM), programmable read-only memory (PROM), magnetic memory, magnetic disk, or optical disk, and volatile memory, such as random access memory (RAM) or static random access memory (SRAM).

The memory 2300 according to an embodiment may store at least one instruction and/or program causing the electronic device 2000 to generate the second content. For example, the memory 2300 may store a content analysis module 2310, a user interface generation module 2320, and a content generation module 2330.

The processor 2400 may control general operations of the electronic device 2000. For example, the processor 2400 may execute one or more instructions of a program stored in the memory 2300 to control general operations in which the electronic device 2000 generate the second content.

The processor 2400 may be configured of at least one of, for example, a central processing unit (CPU), a micro-processor, a graphics processing unit (GPU), an application specific integrated circuit (ASIC), a digital signal processor (DSP), a digital signal processing device (DSPD), a programmable logic device (PLD), a field programmable gate array (FPGA), an application processor (AP), a neural processing unit, or an artificial intelligence-dedicated processor designed in a hardware structure specialized for processing of an artificial intelligence model, but is not limited thereto.

In an embodiment, the processor 2400 may execute the content analysis module 2310 to analyze the first content. The processor 2400 may analyze scenes of the first content by using one or more artificial intelligence models, and obtain information about the first content (e.g., a genre of the first content). Descriptions about operations of the content analysis module 2310 have been described with reference to the above drawings, and thus, redundant descriptions are omitted.

In an embodiment, the processor 2400 may execute the user interface generation module 2320 to generate a user interface for generating the second content. The user interface may include at least one of editable content elements within the first content and generatable content elements within the first content. The user of the electronic device 2000 may select, from the user interface, a content element to be personalized, and generate the second content by editing and/or changing the selected element. The user may edit content by using the electronic device 2000. The electronic device 2000 may display a user interface for editing the content and receive a user input of editing media content from the user. Descriptions about operations of the user interface generation module 2320 have been described with reference to the above drawings, and thus, redundant descriptions are omitted.

In an embodiment, the processor 2400 may execute the content generation module 2330 to generate the second content. The processor 2400 may generate the second content in which characteristics of a content element have been changed by providing features of the first content (e.g., a content element in the first content) to a generative artificial intelligence model as an input. The second content may be combined with the first content and provided to the user as the personalized content. The second content may include at least one of an image, audio, and text. In an embodiment, the second content may be a summary of the first content. The user may receive the summary of the first content through the electronic device 2000. Descriptions about operations of the content generation module 2330 have been described with reference to the above drawings, and thus, redundant descriptions are omitted.

In the present disclosure, a user interface for generating personalized content by using generative artificial intelligence is provided to a user watching content, and the generated personalized content is provided to the user. Technical problems to be achieved by the present disclosure are not limited to the technical problems mentioned above, and other technical problems that are not mentioned will be clearly understood by one of ordinary skill in the art from the following description.

According to an aspect of the present disclosure, a method, performed by an electronic device, of providing content may be provided.

The method may include obtaining information about first content being reproduced.

The method may include generating, based on the information about the first content, a user interface including at least one of editable content elements within the first content and generatable content elements within the first content.

The method may include receiving a user input of selecting a content element through the user interface.

The method may include generating, based on the content element corresponding to the user input, second content corresponding to the first content.

The method may include generating personalized content including the first content and the second content.

The information about the first content may include at least one of a title, a producer, a reproduction time, a genre, cast information, platform information, and channel information.

The method may further include generating scene context data by using a video frame included in the first content.

The method may further include identifying a genre of the first content based on at least one of the information about the first content and the scene context data.

The generating of the user interface may include generating the user interface based on the genre of the first content.

The generating of the user interface may include generating the user interface such that a pre-defined content element corresponding to the genre of the first content is included.

The generating of the second content may include obtaining the second content by inputting the content element corresponding to the user input into a generative artificial intelligence model.

The generative artificial intelligence model may include at least one of a first generative artificial intelligence model generating an image, a second generative artificial intelligence model generating audio, and a third generative artificial intelligence model generating text.

The second content may include at least one of an image, audio, and text.

The method may further include storing the second content in association with user information.

The method may further include providing, based on the reproduction of the first content ending, a summary of the first content to a user.

The providing of the summary of the first content to the user may include generating the summary of the first content in a background process when the first content being reproduced in the electronic device is changed to another content.

According to an aspect of the present disclosure, an electronic device for providing content may be provided.

The electronic device may include a communication interface, a display, memory storing one or more instructions, and at least one processor configured to execute the one or more instructions.

The at least one processor may be configured to execute the one or more instructions to obtain information about first content being reproduced.

The at least one processor may be configured to execute the one or more instructions to generate, based on the information about the first content, a user interface including at least one of editable content elements within the first content and generatable content elements within the first content.

The at least one processor may be configured to execute the one or more instructions to receive a user input of selecting a content element through the user interface.

The at least one processor may be configured to execute the one or more instructions to generate, based on the content element corresponding to the user input, second content corresponding to the first content.

The at least one processor may be configured to execute the one or more instructions to display, on a screen of the display, personalized content including the first content and the second content.

The information about the first content may include at least one of a title, a producer, a reproduction time, a genre, cast information, platform information, and channel information.

The at least one processor may be configured to execute the one or more instructions to generate scene context data by using a video frame included in the first content.

The at least one processor may be configured to execute the one or more instructions to identify a genre of the first content based on at least one of the information about the first content and the scene context data.

The at least one processor may be configured to execute the one or more instructions to generate the user interface based on the genre of the first content.

The at least one processor may be configured to execute the one or more instructions to generate the user interface such that a pre-defined content element corresponding to the genre of the first content is included.

The at least one processor may be configured to execute the one or more instructions to obtain the second content by inputting the content element corresponding to the user input into a generative artificial intelligence model.

The generative artificial intelligence model may include at least one of a first generative artificial intelligence model generating an image, a second generative artificial intelligence model generating audio, and a third generative artificial intelligence model generating text.

The at least one processor may be configured to execute the one or more instructions to store the second content in association with user information.

The at least one processor may be configured to execute the one or more instructions to provide, based on the reproduction of the first content ending, a summary of the first content to a user.

The at least one processor may be configured to execute the one or more instructions to generate the summary of the first content in a background process when the first content being reproduced in the electronic device is changed to another content.

The embodiments of the present disclosure may also be realized in the form of a recording medium including instructions executable by a computer, such as a program module executed by a computer. A computer-readable medium may be an arbitrary available medium accessible by a computer, and includes all volatile and non-volatile media and separable and non-separable media. Further, examples of the computer-readable recording medium may include a computer storage medium and a communication medium. Examples of the computer storage medium include all volatile and non-volatile media and separable and non-separable media, which have been implemented by an arbitrary method or technology, for storing information such as computer-readable instructions, data structures, program modules, and other data. The communication medium may typically include other data of a modulated data signal, such as a computer-readable instruction, a data structure, or a program module.

The computer-readable storage medium may be provided in the form of a non-transitory storage medium. Here, the “non-transitory storage medium” only denotes a tangible device and does not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

According to an embodiment, a method according to various embodiments disclosed in the present specification may be provided by being included in a computer program product. The computer program products are products that can be traded between sellers and buyers. The computer program product may be distributed in the form of machine-readable storage medium (for example, a compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

The above description of the present disclosure is provided for illustration, and it will be understood by one of ordinary skill in the art that various changes in form and details may be readily made therein without departing from essential features and the scope of the present disclosure as defined by the following claims. Accordingly, embodiments described above are examples in all aspects and are not limited. For example, each element described as a single type may be implemented in a distributed manner, and similarly, elements described as distributed may be implemented in a combined form.

The scope of the present disclosure is defined by the appended claims rather than the detailed description, and all changes or modifications within the scope of the appended claims and their equivalents will be construed as being included in the scope of the present disclosure.

What is claimed is:

1. A method performed by an electronic device, the method comprising:
obtaining information in relation to first content being reproduced;
generating, based on the information in relation to the first content, a user interface including at least one of an editable content element in relation to the first content and a generatable content element in relation to the first content;
receiving a user input selecting a content element through the user interface;
generating, based on the content element being selected according to the user input, second content corresponding to the first content; and
generating personalized content including the first content and the second content.

2. The method of claim 1, further comprising:
generating scene context data by using a video frame included in the first content; and
identifying a genre of the first content based on at least one of the information in relation to the first content and the scene context data,
wherein the generating of the user interface comprises:
generating the user interface based on the genre of the first content.

3. The method of claim 2, wherein
the generating of the user interface comprises:
generating the user interface such that a pre-defined content element corresponding to the genre of the first content is included.

4. The method of claim 1, wherein
the generating of the second content comprises:
obtaining the second content by inputting the content element corresponding to the user input into a generative artificial intelligence model.

5. The method of claim 4, wherein
the generative artificial intelligence model comprises at least one of a first generative artificial intelligence model generating an image, a second generative artificial intelligence model generating audio, and a third generative artificial intelligence model generating text.

6. The method of claim 1, further comprising:
providing, based on completion of the first content being reproduced, a summary of the first content to a user.

7. The method of claim 6, wherein
the providing of the summary of the first content to the user comprises:
generating the summary of the first content in a background process based on the first content being reproduced in the electronic device is changed to another content.

8. An electronic device for providing content, the electronic device comprising:
a communication interface;
a display;
a memory to store one or more instructions; and
at least one processor configured to execute the one or more instructions stored in the memory to:
obtain information in relation to first content being reproduced;
generate, based on the information in relation to the first content, a user interface including at least one of an editable content element in relation to the first content and a generatable content element in relation to the first content;
receive a user input selecting a content element through the user interface;
generate, based on the content element being selected according to the user input, second content corresponding to the first content; and
display, on a screen of the display, personalized content including the first content and the second content.

9. The electronic device of claim 8, wherein
the at least one processor is configured to execute the one or more instructions to:
generate scene context data by using a video frame included in the first content;
identify a genre of the first content based on at least one of the information in relation to the first content and the scene context data; and
generate the user interface based on the genre of the first content.

10. The electronic device of claim 9, wherein
the at least one processor is configured to execute the one or more instructions to generate the user interface such that a pre-defined content element corresponding to the genre of the first content is included.

11. The electronic device of claim 8, wherein
the at least one processor is configured to execute the one or more instructions to obtain the second content by inputting the content element corresponding to the user input into a generative artificial intelligence model.

12. The electronic device of claim 11, wherein
the generative artificial intelligence model comprises at least one of a first generative artificial intelligence model generating an image, a second generative artificial intelligence model generating audio, and a third generative artificial intelligence model generating text.

13. The electronic device of claim 8, wherein
the at least one processor is configured to execute the one or more instructions to provide, based on completion of the first content being reproduced, a summary of the first content to a user.

14. The electronic device of claim 13, wherein
the at least one processor is configured to execute the one or more instructions to generate the summary of the first content in a background process based on the first content being reproduced in the electronic device is changed to another content.

15. A non-transitory computer-readable recording medium having recorded thereon a program which, when executed by at least one processor of an electronic device, controls the electronic device to perform operations comprising:
obtaining information in relation to first content being reproduced;
generating, based on the information in relation to the first content, a user interface including at least one of an editable content element in relation to the first content and a generatable content element in relation to the first content;
receiving a user input selecting a content element through the user interface;
generating, based on the content element being selected according to the user input, second content corresponding to the first content; and
generating personalized content including the first content and the second content.
